(19) United States
(12) Patent Application Publication
(10) Pub. No.: US 2007/0272801 A1
(43) Pub. Date: Nov. 29, 2007

(54) Autonomously controlled GPS-guided parafoil recovery apparatus

(76) Inventors: Donald Patrick Hilliard, Camarillo, CA (US); Glenda Esnardo Hilliard, Camarillo, CA (US); Michael Patrick Hilliard, Camarillo, CA (US); Christina Ann Hilliard, Camarillo, CA (US)

Correspondence Address: NAVAIRWD COUNSEL GROUP, 575 "I" AVE, SUITE 1 (CODE K00000E), BUILDING 36, ROOM 2308, POINT MUGU, CA, 93042-5049, US

(21) Appl. No.: 11/440,566

(22) Filed: May 24, 2006

(51) Int. Cl. B64D 17/00

(52) U.S. Cl. 244/142

(57) ABSTRACT

A GPS-guided parafoil recovery system which provides for the recovery of a radiosonde sensor and other electronic equipment and weather balloon without damage by allowing for a safe, non-destructive precision landing of the sensor at a specified landing site. The recovery system includes a parafoil having a plurality of control lines and an electro-mechanical motor drive unit. The motor drive unit has control electronics and servo motors which are used to control the glide path trajectory of the parafoil and provide for a safe non-destructive precision landing of the sensor by adjusting the length of each of control lines of the parafoil as the parafoil travels to the landing site.

### BACKGROUND OF THE INVENTION

1. Field of the Invention

The present invention relates generally to weather balloons and the ability to recover weather balloons. More particularly, the present invention relates to an autonomously controlled GPS-guided parafoil recovery apparatus which allows for precision recovery of a weather balloon and radiosonde equipment and other electronic equipment such as cell phone relays attached to the weather balloon.

2. Description of the Prior Art

Weather balloons which carry radiosonde sensor and telemetry packages are recovered with traditional parachute systems after the balloon deflates and the system descends towards the ground. These parachute recovery systems have generally been ineffective for recovering most weather balloons and sensor and electronic equipment which are lost.

Since high altitude winds often carry weather balloons and sensor equipment long distances from a launch area and parachute technology currently in use does not allow for control over the variations and randomness in a flight path, about 80% of the approximately 75,000 weather balloon systems launched each year are not recovered. As a result, resources are wasted that could be recovered and reused. In addition to the high cost of balloon and weather related sensor equipment that may include other electronics, such as cell phone relays, that are reusable, the equipment creates environmental and wildlife hazards, especially when the weather balloons, parachutes, parachute lines and radiosonde equipment return to earth.

Accordingly, there is a need for an apparatus which allows for recovery of weather balloons and weather related sensor equipment when the balloons and equipment descend to earth.

### SUMMARY OF THE INVENTION

The present invention overcomes some of the disadvantages of the past including those mentioned above in that it comprises a relatively simple in design yet high effective autonomously controlled GPS-guided parafoil recovery apparatus which allows for precision recovery of a weather balloon and radiosonde sensor equipment attached to the weather balloon. The recovery apparatus is designed to fly the weather balloons and sensor equipment attached to the weather balloon to a designated recovery area.

The parafoil recovery system of the present invention comprises a parafoil and an electro-mechanical motor drive unit which includes guidance control electronics and servo motors designed to guide the weather balloon and sensor equipment. The parafoil, which is rectangular in shape, is connected by a plurality of control lines to a guidance control electronics and servo system, which is attached to the payload.

The guidance control electronics and servo motors is used to control glide path trajectory and provide for a safe non-destructive landing of the payload. The servo motors adjusts the length of each of the plurality of control lines attached to the parafoil to provide a means for controlling the parafoil so as to control the speed, direction and lift of the GPS-guided parafoil recovery apparatus.

An antenna and its associated GPS receiver receives GPS data from transmitting satellites. The GPS data is processed by the GPS electronics to determine real-time longitude, latitude and altitude data as well as rate of descent data which the guidance control electronics and servo system processes to steer the parafoil to a precise location and to control the rate of descent of the recovery system allowing for a gentle touchdown and soft landing of the payload. The guidance and control electronics includes processing that corrects for wind disturbances on the flight profile.

The guidance control electronics and servo motors include a guidance control device/digital computer and at least four servo motors. Each servo motor adjust the length of one of the control lines to steer the parafoil recovery system to a safe non-destructive landing of the payload.

### BRIEF DESCRIPTION OF THE DRAWINGS

FIG. 1 illustrates an autonomously controlled GPS-guided parafoil recovery system which allows for the recovery of an inflatable weather balloon and a radiosonde sensor package, that may include other electronics such as cell phone relays, attached to the weather balloon;

FIG. 2 illustrates the parafoil recovery system after the weather balloon deflates and a parafoil is deployed;

FIG. 3 illustrates another embodiment of the autonomously controlled GPS-guided parafoil recovery system comprising the present invention;

FIG. 4 illustrates a third embodiment of the autonomously controlled GPS-guided parafoil recovery system comprising the present invention; and

FIG. 5 illustrates a side view of the electro-mechanical motor drive unit for the parafoil recovery system of the present invention.

### DETAILED DESCRIPTION OF A PREFERRED EMBODIMENT

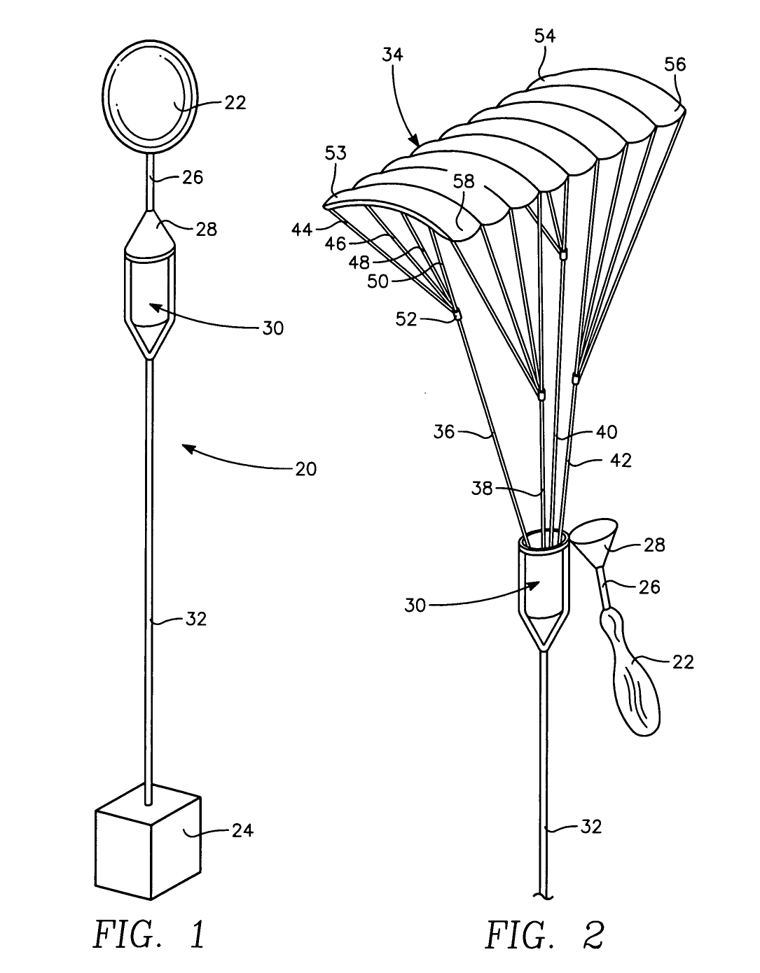

Referring to FIGS. 1-4, there is shown an autonomously controlled GPS-guided parafoil recovery apparatus 20 which allows for the recovery of an inflatable weather balloon 22 and a radiosonde sensor package/payload 24 attached to the weather balloon 22. The radiosonde sensor package 24 may include other electronic systems, such as cell phone relays. The parafoil recovery apparatus 20 includes inflatable weather balloon 22 which is connected by a line 26 and an upper cone shaped support structure 28 to the upper end of a parafoil recovery system 30. Parafoil recovery system 30 is a storage container for the parafoil prior to its release from system 20 and subsequent deployment. Cone shaped support structure 28 operates as a lid for parafoil recovery system 30. A line 32 attached to the bottom end of parafoil recovery system 30 connects the parafoil recovery system 30 to the radiosonde sensor package 24.

For the configuration of recovery apparatus 20 in FIG. 1, the length of line 26 separating parafoil recovery system 30 and weather balloon 22 is approximately 1.5 meters. The length of the recovery apparatus 20 from balloon 22 to the radiosonde sensor package is generally within a range of 21 meters to 36 meters and is preferably 26 meters.

Referring to FIG. 2, the GPS-guided parafoil recovery apparatus 20 is shown in a descent and recovery mode after weather balloon 22 has burst from ascending to its maximum altitude. Cone shaped support structure 28 is attached to system 30 by a hinge which allows support structure 28 to release from system 30 in the manner illustrated in FIG. 2. After the balloon 22 deflates, the GPS-guided parafoil recovery apparatus 20 descends to an altitude that is appropriate for parafoil flight at which point the support structure 28 is released which opens parafoil recovery system 30. Opening parafoil recovery system 30 allows a parafoil 34 to jettison from the parafoil recovery system 30 and deploy in the manner illustrated in FIG. 2. Support structure 28 is hinged over in the manner illustrated in FIG. 2.

The parafoil 34, which is rectangular in shape, includes four separate control lines 36, 38, 40 and 42. Each separate control line 36, 38, 40 and 42 includes at its upper end a set of four attachment lines 44, 46, 48 and 50 and a connecting element 52 which secures each control line 36, 38, 40 or 42 to its associated set of attachment lines 44, 46, 48 and 50. The opposite ends of each set of attachment lines 44, 46, 48 and 50 are attached to the parafoil 34. As shown in FIG. 2 each control line's associated attachment lines 44, 46, 48 and 50 are attached to one of four quadrant sections 53, 54, 56 and 58 of parafoil 34.

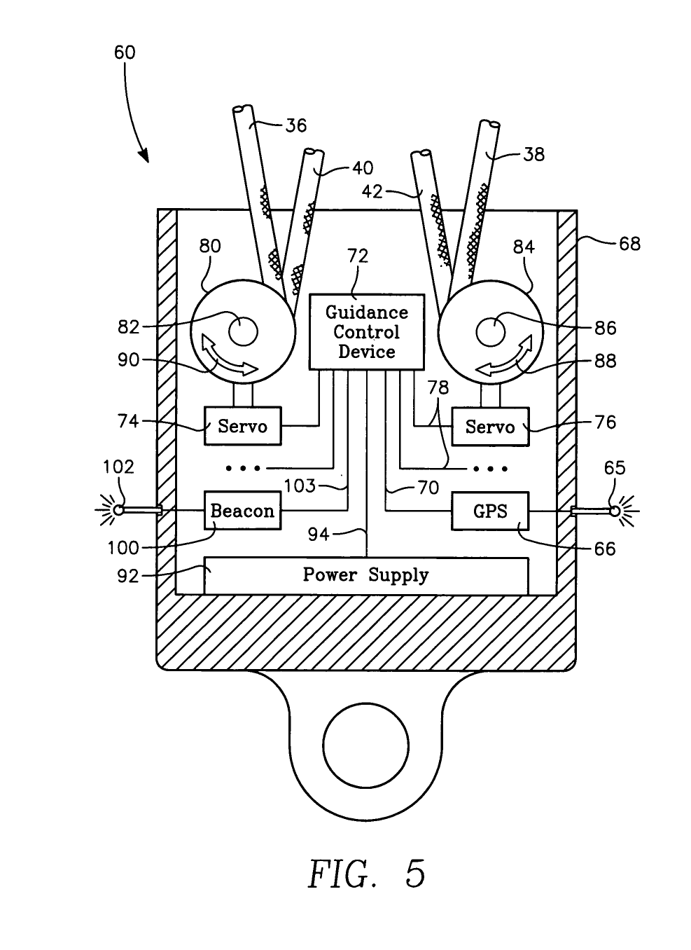

The opposite end of each control line 36, 38, 40 and 42 is attached to an electro-mechanical motor drive unit 60 for parafoil recovery system 30 which is illustrated in FIG. 5. The control lines 36, 38, 40 and 42 in combination with the electro-mechanical motor drive unit 60 provide for flight control of parafoil recovery apparatus 20 as the parafoil recovery apparatus 20 descends to a designated recovery area along an optimal flight path, which is determined by real-time adaptive processing in a microprocessor contained in the guidance control device 72 of electro-mechanical motor drive unit 60 shown in FIG. 5. This flight control allows recovery of the radiosonde sensor package 24 and weather balloon 22 with minimal damage to either sensor package 24 or weather balloon 22.

At this time, it should be noted that other configurations of control lines and their associated motor drives may be utilized for flight control of the recovery apparatus 20 as recovery apparatus 20 descends to its designated landing site. For example, parafoil control lines can be arranged as a pair of control lines controlled by two motor drives or six control lines controlled by six motor drives. Furthermore, bracing structures may be used near parafoil recovery system 30 to keep control lines separated near the electro-mechanical motor drive unit 60.

It should also be noted that the sensor equipment package 24 includes a Radiosonde which is a unit designed for use in weather balloons that measures various atmospheric parameters and then transmits the measured atmospheric parameters to a fixed receiver. A radio frequency of 403 MHz is reserved for transmission of the measured atmospheric parameters to a fixed receiver by a Radiosonde. Sensor equipment package 24 may include electronics other than atmospheric sensors such as cell relays.

A Radiosonde is tied to a helium or hydrogen filled balloon, which lifts the device up through the atmosphere. The maximum altitude the balloon ascends to is determined by the size of the balloon or weight of the balloon material. Balloon sizes can range from about 150 grams to about 3000 grams. An 800 gram balloon will generally burst at about 100,000 feet or 30,000 meters due to lack of external pressure at that altitude. The weight of a Radiosonde is typically 250 grams and Radiosondes are commercially available from various sources such as Vaisala in Finland.

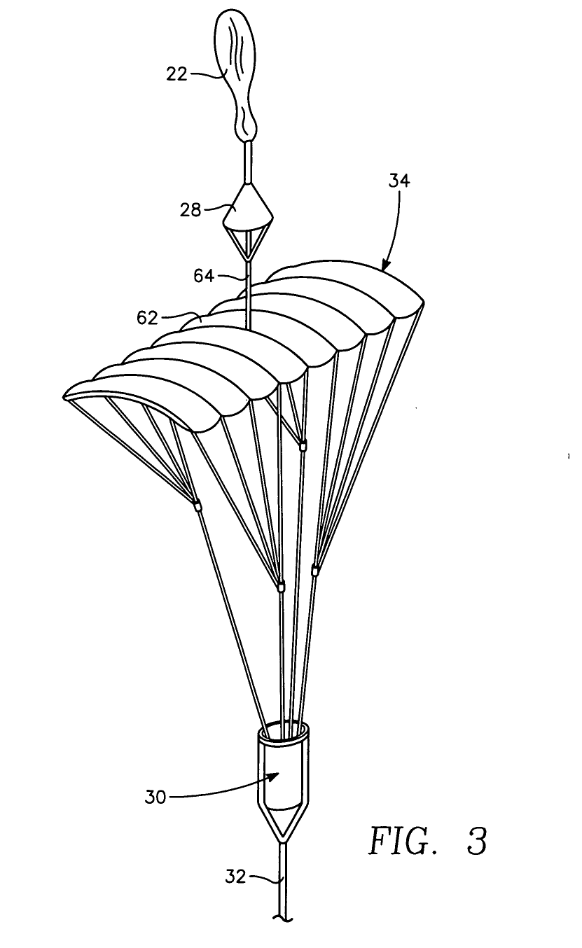

Referring to FIG. 3, the autonomously controlled GPS-guided parafoil recovery apparatus 20 is shown in a descent mode with the deflated balloon 22 positioned above parafoil 34. In this embodiment the cone shaped support structure 28 is attached to the upper surface 62 of parafoil 34 and the parafoil 34 is connected to cone shaped support structure 28 via an extension line 64. After balloon 22 burst, the cone shaped support structure 28 acts as an opening assist for parafoil 34 pulling parafoil 34 from the parafoil recovery system 30, when GPS-guided parafoil recovery apparatus 20 descends to an appropriate altitude for parafoil flight, such as, for example 5000 feet. As the parafoil recovery apparatus 20 descends air flow to the inside of support structure 28 exerts an upward force on support structure 28. Support structure 28 is released from recovery system 30 at the appropriate altitude for parafoil flight removing the parafoil 34 from the parafoil recovery system 30. As shown in FIG. 3, the cone shaped support structure 28 completely disconnects from system 30 to allow for removal and deployment of parafoil 34.

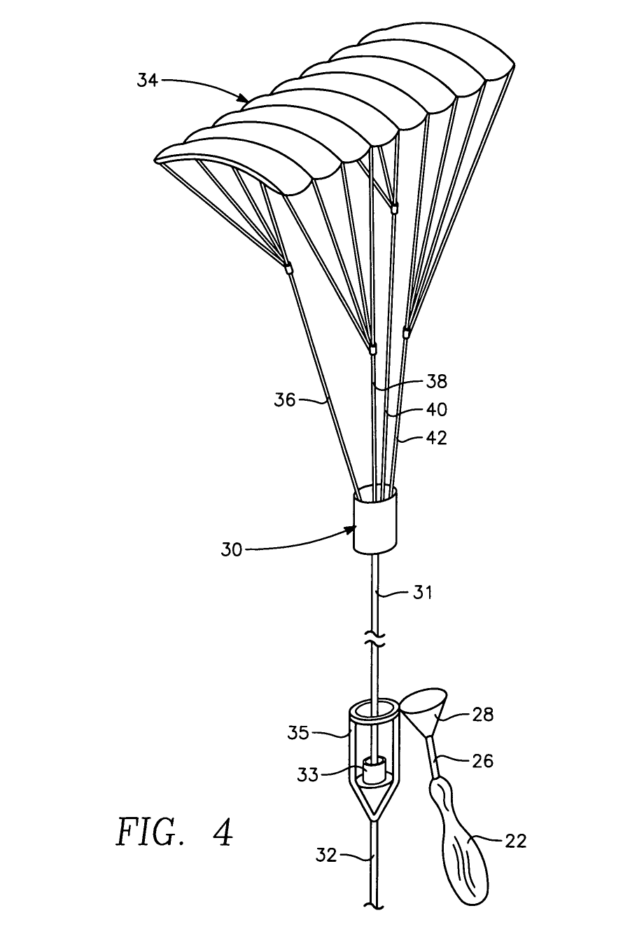

Referring to FIG. 4, there is shown another embodiment of the autonomously controlled GPS-guided parafoil recovery apparatus 20 which allows for a safe non-destructive landing of the radiosonde sensor package/payload 24. In FIG. 4, the parafoil recovery system is shown above the balloon 22 after the balloon 22 bursts recovery apparatus 20 descends to an appropriate altitude, and the parafoil 34 is deployed. In this embodiment, the electro-mechanical motor drive unit 60 which controls control lines 36, 38, 40 and 42 of parafoil 34 is located within recovery system 30.

An extension line 31 connects the recovery system 30 to a spooler 33 within the recovery system support frame 35. Spooler 33 is attached to the base of support frame 35 and is designed to un-reel extension line 31 to allow for the deployment of the recovery system 30 and parafoil 34.

In the embodiment illustrated in FIG. 4, support frame 35 is utilized as a means to transfer the load bearing from the balloon 22 to the parafoil 34 during a controlled descent to prevent entanglement of the balloon 22, line 26 and cone shaped support structure 28 with the parafoil 34 and control lines 36, 38, 40 and 42.

Referring to FIGS. 2 and 5, FIG. 5 illustrates the electro-mechanical motor drive unit 60 for parafoil recovery system 30 of autonomously controlled GPS-guided parafoil recovery apparatus 20. The electro-mechanical motor drive unit 60 functions as the guidance control electronics and servo system for parafoil recovery system 30 after the weather balloon 22 burst and recovery apparatus 20 descends to an appropriate altitude for optimal parafoil flight. Electro-mechanical motor drive unit 60 is used to control glide path trajectory and provide for a safe non-destructive landing of the payload 24. Electro-mechanical motor drive unit 60 adjusts the length of each of the control lines 36, 38, 40, and 42 providing a means for controlling parafoil 34 so as to control the speed, direction and lift of parafoil recovery system 30.

Payload trajectory control in the air is accomplished by controlling the relative location of the parafoil 34 and the payload 24 and varying the angle of attack of the parafoil 34. Payload trajectory control in the air may, for example, be accomplished by lowering a portion of the back of parafoil 34. This requires shortening control lines 36 and 40. Further, payload trajectory control in the air may also be accomplished by lowering a portion of the front of parafoil 34. This requires shortening control lines 38 and 42.

Referring to FIG. 5, the electro-mechanical motor drive unit 60 used in the preferred embodiment of the present invention includes an antenna 65 and its associated GPS receiver 66 which receives externally generated RF signals which include GPS data. These RF signals including GPS data are used by the electro-mechanical motor drive unit 60 to direct the flight of the parafoil recovery system 30. These externally generated RF signals are transmitted from GPS satellites or from a transmitting station. The GPS or other position data is provided in a radio frequency signal format from the transmitting station or satellites. The GPS receiver 66 uses RF signals transmitted from GPS satellites to calculate in real time the position of recovery system 30 including longitude, latitude and altitude data as well as direction and velocity of recovery system 30 and rate of descent data which the guidance control device 72 processes to steer the recovery system 30 to a precise location and to control the rate of descent of the recovery system 30 allowing for a gentle touchdown and soft landing of payload 24. The guidance control device 72 also is programmed to provide target landing area coordinates defining a target landing area for said parafoil recovery system.

The guidance control device 72 includes a microprocessor with adaptive guidance algorithms for continuous flight path control of recovery system 30 to a designated landing area. Examples of such algorithms are Kalman filters which can be adaptively modified as flight dynamics for recovery system 30 change from one moment to the next including changes caused by winds, insuring that recovery system 30 travels an optimal flight path to a designated landing area. Guidance control device 72 continuously updates flight dynamics information received from GPS receiver 66.

As shown in FIG. 5 antenna 65 and GPS receiver 66 are mounted within a support structure 68 which has the electro-mechanical elements of the electro-mechanical motor drive unit 60 mounted therein. Antenna 65 and receiver 66 may also be mounted elsewhere within parafoil recovery system 30, and not limited to being mounted in support structure 68 as shown in FIG. 3.

The GPS data continuously calculated by GPS receiver 66 is transferred via an electrical cable 70 to a guidance control device 72. The guidance control device 72 then continuously processes the GPS position and flight dynamics data with a microprocessor containing flight control algorithms which calculates a continuously updated optimal flight path, generating a plurality of digital positioning commands/signals which are converted to an analog format prior to being supplied to a plurality of servo motors 74 and 76. The guidance control device includes a digital to analog converter board to convert the digital signals to an analog format. Electrical cables 78 connect each of the plurality of servo motors 74 and 76 to guidance control device 72.

The microprocessor in guidance control device 72 continuously receives position and velocity (including decent rate) updates from GPS receiver 66 and calculates an updated optimal flight path including corrections for wind. These calculations are then used to correctly maneuver parafoil 34 via servo motors 74 and 76.

At this time it should be noted that guidance control device 72 may be a commercial available light weight, compact, impact resistant digital computer or microprocessor.

The plurality of servo motors each have a shaft and a capstan/spool attached to the shaft of the servo motor. As shown in FIG. 5, capstan 80 is attached to the servo motor shaft 82 for servo 74, while capstan 84 is attached to the servo motor shaft 86 for servo 76. Control line 36 is wound around capstan 80 and control line 38 is wound around capstan 84. Each of the remaining control lines 40 and 42 has a servo motor associated with the control line 40 or 42.

The capstan 84 rotates in the clockwise direction to lengthen/extend control line 38 and in the counterclockwise direction to shorten/retract control line 38 (as indicated by arrow 88). The capstan 80 rotates in the counterclockwise direction to lengthen/extend control line 36 and in the clockwise direction to shorten/retract control line 36 (as indicated by arrow 90).

There is a rechargeable battery/power supply 92 mounted within support structure 68 which is connected to guidance control device 72 by an electrical cable 94 to supply power to guidance control device 72. Power for the servos 74 and 76 is routed through guidance control device 72 and electrical cables 78 to each servo 74 and 76. Power for recharging the battery 92 is generally provided by a recharging station at ground facility.

The recovery system 30 also includes a beacon 100 which has an antenna 102 for transmitting radio frequency signals to the ground station. These radio frequency signals provide data relating to the altitude of recovery system 30, the rate of descent of recovery system 30, direction of flight of recovery system 30 and the current position of recovery system 30 including its latitude and longitude. this information is used by the ground station personnel to track recovery system 30 and identify the approximate landing site, while beacon 100 provides continuous transmission to recovery personnel.

During the flight of recovery system 30, signals from beacon 100 may be used by ground station personnel to compute flight trajectory and override guidance control device if necessary. For example, ground station personnel may want to change the landing site stored in the microprocessor of device 72 to a different landing site by overriding the decisions made by the microprocessor to control the flight path of parafoil 34.

Computers at the ground station process beacon 100 signal data calculating new optimal flight path and a rate of descent which is then transmitted to the guidance control device 72. An electrical cable 103 connects the guidance control device 72 to beacon 100.

Upon receiving new flight trajectory information from the ground station, the guidance control device 72 generates new positioning signals which are supplied to the servos for each of the control lines 36, 38, 40, and 42 adjusting the length of each of the control lines 36, 38, 40, and 42 as required to steer the parafoil recovery system 30 on a flight path which allows for a gentle touchdown and soft landing of payload 24.

From the foregoing, it may readily be seen that the present invention comprises a new, unique and exceedingly useful parafoil recovery system which constitutes a considerable improvement over the known prior art. Many modifications and variations of the present invention are possible in light of the above teachings. It is to be understood that within the scope of the appended claims the invention may be practiced otherwise than as specifically described.

What is claimed is:

1. A GPS-guided parafoil recovery system for recovery a weather balloon after said weather balloon burst and said parafoil recovery system descends to an appropriate altitude for parafoil flight, comprising:
(a) a generally rectangular shaped parafoil;
(b) a plurality of control lines, said control lines each having one end thereof connected to said parafoil at a selected location on said parafoil and an opposite end;
(c) a GPS receiver having an antenna for receiving RF (radio frequency) from external satellites, said RF signals comprising GPS satellite position data from which said GPS receiver computes longitude, latitude, altitude, direction, velocity, and rate of descent data for said parafoil;
(d) a guidance control device programmed to provide target landing area coordinates defining a specified target landing area for said GPS-guided parafoil recovery system, said guidance control device being connected to said GPS receiver to receive GPS position, direction, velocity and rate of descent data computed by said GPS receiver, wherein said guidance control device is programmed with adaptive flight control algorithms to make continuous real time flight control corrections which are in response to said GPS position, direction, velocity and rate of descent data;
(e) a plurality of servo motors connected to said guidance control device, each of said servo motors having a shaft and a capstan attached to the shaft of each of said servo motors, the capstan of each of said servo motors having the opposite end of one of said plurality of control lines connected thereto;
(f) said guidance control device processing said GPS position, direction, velocity and rate of descent data and said target landing area coordinates to generate a plurality of positioning signals, said guidance control device providing said positioning signals to said plurality of servo motors;
(g) said plurality of servo motors, responsive to said positioning signals from said guidance control device, rotating said capstans to continuously and separately adjust the length of each of said control lines steering said parafoil on a flight path to a non-destructive precision landing of said GPS-guided parafoil recovery system within said specified target landing area; and
(h) a radiosonde sensor and electronic communication package removably coupled to said parafoil to allow said radiosonde sensor and electronic communication package to be removed from said parafoil after the non-destructive precision landing of said GPS guided parafoil recovery system said specified target landing area.

2. The parafoil recovery system of claim 1 wherein said plurality of control lines comprises four uniformly spaced apart control lines having one end attached to said parafoil.

3. The parafoil recovery system of claim 2 wherein said plurality of servo motors comprises four servo motors with the capstan of each of said four servo motors being connected to one the said four control lines wherein said four servo motors continuously and separately adjust the length of each of said four control lines steering said parafoil on a flight path to the non-destructive precision landing of said GPS-guided parafoil recovery system within said target landing area.

4. The parafoil recovery system of claim 1 further comprising a beacon having an antenna for transmitting radio frequency signals which provide location data for said GPS-guided parafoil recovery system relating to a direction of flight of said GPS-guided parafoil recovery system and a current position for said GPS-guided parafoil recovery system, and a rate of descent of said GPS-guided parafoil recovery system.

5. The parafoil recovery system of claim 1 wherein said servo system further comprises a power supply connected to said guidance control device to supply power to said guidance control device.

6. The parafoil recovery system of claim 1 wherein said guidance control device comprises a digital computer.

7. The parafoil recovery system of claim 1 wherein said guidance control device comprises a microprocessor.

8. The parafoil recovery system of claim 1 further comprising a storage container for storing said parafoil prior to said parafoil being released from said storage container at said appropriate altitude for parafoil flight and deployed into the atmosphere, said parafoil when deployed providing for a controlled descent and said non-destructive precision landing of said GPS-guided parafoil recovery system within said specified target landing area.

9. The parafoil recovery system of claim 8 further comprising a cone shaped support structure mounted on an upper end of said storage container, said cone shaped support structure operating as a lid opening after said weather balloon burst and said parafoil recovery system descends to said appropriate altitude for parafoil flight which allows for deployment of said parafoil into the atmosphere.

10. A GPS-guided parafoil recovery system for recovery a weather balloon after said weather balloon burst and said parafoil recovery system descends to an appropriate altitude for parafoil flight, comprising:
(a) a generally rectangular shaped parafoil;
(b) first, second, third and fourth control lines having one end thereof connected to said parafoil in proximity to each of four corners of said parafoil and an opposite end;
(c) a GPS receiver having an antenna for receiving RF (radio frequency) from external satellites, said RF signals comprising GPS satellite position data from which said GPS receiver computes longitude, latitude, altitude, direction, velocity, and rate of descent data for said parafoil;
(d) a guidance control device programmed to provide target landing area coordinates defining a specified target landing area for said GPS-guided parafoil recovery system, said guidance control device being connected to said GPS receiver to receive GPS position, direction, velocity and rate of descent data computed by said GPS receiver, wherein said guidance control device is programmed with adaptive flight control algorithms to make continuous real time flight control corrections which are in response to said GPS position, direction, velocity and rate of descent data;
(e) first, second, third and fourth servo motors connected to said guidance control device, each of said servo motors having a shaft and a capstan attached to the shaft of each of said first, second, third and fourth servo motors, the capstan of each of said first, second, third and fourth servo motors having the opposite end of one of said first, second, third and fourth control lines connected thereto;
(f) said guidance control device processing said GPS position, direction, velocity and rate of descent data and said target landing area coordinates to generate a plurality of positioning signals, said guidance control device providing said positioning signals to said first, second, third and fourth servo motors;
(g) said first, second, third and fourth servo motors, responsive to said positioning signals from said guidance control device, rotating said capstans to continuously and separately adjust the length of each of said control lines steering said parafoil on a flight path to a non-destructive precision landing of said GPS-guided parafoil recovery system within said specified target landing area; and
(h) a radiosonde sensor and electronic communication package removably coupled to said parafoil to allow said radiosonde sensor and electronic communication package to be removed from said parafoil after the non-destructive precision landing of said GPS guided parafoil recovery system said specified target landing area.

11. The parafoil recovery system of claim 10 further comprising a beacon having an antenna for transmitting radio frequency signals which provide location data for said GPS-guided parafoil recovery system relating to a direction of flight of said GPS-guided parafoil recovery system and a current position for said GPS-guided parafoil recovery system.

12. The parafoil recovery system of claim 10 wherein said servo system further comprises a power supply connected to said guidance control device to supply power to said guidance control device.

13. The parafoil recovery system of claim 10 wherein said guidance control device comprises a digital computer.

14. The parafoil recovery system of claim 10 wherein said guidance control device comprises a microprocessor.

15. The parafoil recovery system of claim 10 further comprising a storage container for storing said parafoil prior to said parafoil being released from said storage container at said appropriate altitude for parafoil flight and deployed into the atmosphere, said parafoil when deployed providing for a controlled descent and said non-destructive precision landing of said GPS-guided parafoil recovery system within said specified target landing area.

16. The parafoil recovery system of claim 15 further comprising a cone shaped support structure mounted on an upper end of said storage container, said cone shaped support structure operating as a lid opening after said weather balloon burst and said parafoil recovery system descends to said appropriate altitude for parafoil flight which allows for deployment of said parafoil into the atmosphere.

17. A method for deploying and retrieving a weather balloon and a radiosonde sensor and electronics communications package removably coupled to said weather balloon comprising:
(a) deploying said weather balloon and said radiosonde sensor and electronics communications package to an altitude at which said weather balloon burst, the altitude to which said weather balloon and said radiosonde sensor and electronics communications package ascend being dependent upon a size for said weather balloon.
(b) deploying a parafoil after said weather balloon burst, and said parafoil recovery system descends to an appropriate altitude for parafoil flight wherein said parafoil is attached to said weather balloon and said radiosonde sensor and electronics communications package;
(c) generating RF signals comprising GPS satellite position data which includes longitude, latitude, altitude, direction, velocity and rate of descent data for said parafoil and said radiosonde sensor and electronics communications package;
(d) receiving said RF signals comprising said GPS satellite position data, wherein a GPS receiver has an antenna which receives said RF signals comprising said GPS satellite position data from external satellites and computes GPS position, direction, velocity and rate of descent data from said GPS satellite position data received by said GPS receiver;
(e) processing said GPS position, direction, velocity and rate of descent data including said longitude, latitude, altitude, direction, velocity and rate of descent data for said parafoil and said radiosonde sensor and electronics communications package, wherein a guidance control device processes said GPS position, direction, velocity and rate of descent data;
(f) generating a plurality of digital positioning signals, wherein said guidance control device processes said GPS position, direction, velocity and rate of descent data to generate real-time continuously updated flight trajectory and associated control signals for said digital positioning signals;
(g) converting said digital positioning signals to an analog positioning signals
(h) providing said analog positioning signals to a plurality of servo motors wherein each of said servo motors has a shaft and a capstan attached to the shaft of each of said servo motors, the capstan of each of said servo motors having one end attached to one of a plurality of control lines, the opposite end of said plurality of control lines being attached to said parafoil;
(i) steering said parafoil on a flight path to a non-destructive precision landing of said parafoil and said radiosonde sensor and electronics communications package within a specified target landing area; and
(j) rotating said capstans to continuously and separately adjust the length of each of said control lines to steer said parafoil on said flight path to said non-destructive precision landing wherein said servo motors, responsive to said analog positioning signals, continuously and separately adjust the length of each of said control lines to steer said parafoil.

18. The method of claim 17 further comprising the step of providing a storage container having a lid which opens after said weather balloon burst and said parafoil recovery system descends to said appropriate altitude for said parafoil flight to deploy said parafoil allowing said parafoil when deployed to provide for a controlled descent and said non-destructive precision landing of said parafoil and radiosonde sensor and electronics communications package within said specified target landing area.

19. The method of claim 17 wherein said plurality of control lines comprises four control lines and said plurality of servo motors comprises four servo motors wherein the capstan for each of said four servo motors is connected one of said four control lines.

20. The method of claim 17 further comprising the step of providing a beacon having an antenna for receiving updated flight trajectory information from a ground station, wherein said updated flight trajectory information is supplied to said guidance control device which in response to said updated flight trajectory information steers said parafoil recovery system to another target landing area.
